(19) United States
(12) Patent Application Publication
(10) Pub. No.: US 2019/0073895 A1
(43) Pub. Date: Mar. 7, 2019

(54) ALARM SYSTEM

(71) Applicant: Timetec Holding Sdn Bhd, PUCHONG (MY)

(72) Inventors: KOK LOONG PANG, Puchong (MY); HON SENG TEH, Puchong (MY)

(73) Assignee: Timetec Holding Sdn Bhd, PUCHONG (MY)

(21) Appl. No.: 16/059,432

(22) Filed: Aug. 9, 2018

(30) Foreign Application Priority Data
Sep. 7, 2017 (MY) PI 2017703271

(51) Int. Cl. G08B 27/00; G08B 26/00

(52) U.S. Cl. CPC G08B 27/00; G08B 26/007

(57) ABSTRACT

An alarm system including a plurality of alarm sensors, each having a BLUETOOTH module to establish communication link using a BLUETOOTH protocol to at least one neighbouring sensor in a way such that a BLUETOOTH Mesh Network is formed, and a controller connected to the BLUETOOTH Mesh Network, configured to monitor and manage the status of each alarm sensor and to trigger at least one alarm device based on the status of the alarm sensors, wherein the status data of each alarm sensor is transmitted to the controller, and vice versa, instructions of the controller are transmitted to at least one sensor via the BLUETOOTH Mesh Network.

### CROSS-REFERENCE TO RELATED APPLICATION

The instant application claims priority to Malaysia Patent Application Ser. No. PI 2017703271 filed Sep. 7, 2017, the entire specification of which is expressly incorporated herein by reference.

### FIELD OF THE INVENTION

The present invention relates generally to an alarm system. More particularly, the present invention relates to a cloud based alarm system in which its components communicate through BLUETOOTH technology.

### BACKGROUND OF THE INVENTION

Conventional alarm systems usually comprise at least one alerting device, a plurality of sensor units placed at the perimeter of the protected area, and a controller unit wirely connected to the sensor units and the alerting device for processing the signals of the sensor and triggering the alerting device. The main drawback of such a system is that the installation of the alarm components can be dangerous when the user does not acquire the proper wiring skill and the hiring of a professional will incur costs.

U.S. Pat. No. 3,939,460 discloses fire alarm and intrusion alarm conductors that are wired from a plurality of dwellings to a nearby data transmitter circuit which is linked by a single pair of conductors to a remote data receiver circuit. The alarm conductors are sequentially scanned in the data transmitter circuit by a binary counter which sequentially enables or opens gates that are coupled to the alarm conductors. When an alarm condition is detected on one of the alarm conductors, the scanning counter is stopped and the counter number is converted from parallel form to serial form. The serial number is transmitted from the data transmitter circuit to the data receiver circuit. The least significant bit of the number signifies whether the alarm is a fire or an intrusion. The remaining bits signify the location. In the receiver circuit, the received data is converted back to parallel form and is printed out on a printer. The transmitted data includes a first bit which is always a binary 1 and a last bit which is always a binary zero. The first bit starts the serial to parallel converter in the receiver circuit and the last bit insures that the output of the parallel to serial converter in the transmitter circuit is left in the low state after the transmission is completed. The data is preferably transmitted from the transmitter circuit to the receiver circuit by frequency shift keying. The data is clocked out of the parallel to serial converter and into the serial to parallel converter by clock pulses which are derived by dividing down the frequency of the frequency shift keying carrier.

U.S. Pat. No. 4,754,263 discloses an alarm system for sensing entry through premise doors and windows, including primary and secondary circuits joined by a transformer. The primary circuit has an alarm including a siren and floodlight plus a time delay relay (with automatic reset) for activating the alarm for preset periods. A siren delay tube permits siren on-off operation in preset cycles. The secondary contains a plurality of automatic resetting door and window switches. A solenoid operated trigger switch has switch contacts wired to energize the time delay relay whereby the trigger switch solenoid is wired in the secondary for actuation by any door or window switch. A rocker switch in the primary selectively energizes the floodlight without activating the siren and selectively deactivates primary power to the transformer in coaction with time delay relay when the siren and floodlight are activated thus deactivating secondary power to the doors and windows.

Therefore, there is a need for new and improved systems and methods for communication between each alarm component to be conducted wirelessly.

### SUMMARY OF THE INVENTION

In accordance with the general teachings of the present invention, an alarm system is provided that includes a plurality of alarm sensors, each having a BLUETOOTH module to establish communication link using a BLUETOOTH protocol to at least one neighbouring sensor in a way such that a BLUETOOTH Mesh Network is formed, and a controller connected to the BLUETOOTH Mesh Network, configured to monitor and manage the status of each alarm sensor and to trigger at least one alarm device based on the status of the alarm sensors, wherein the status data of each alarm sensor is transmitted to the controller, and vice versa, instructions of the controller are transmitted to at least one sensor via the BLUETOOTH Mesh Network.

By BLUETOOTH, as that term is used herein, it is meant to include, without limitation, any wireless technology standard for exchanging data over short distances (e.g., using short-wavelength UHF radio waves in the ISM band from 2.4 to 2.485 GHz) from fixed and mobile telecommunication devices, and building personal area networks (PANs).

Preferably, the at least one alarm device can be connected to the controller via the BLUETOOTH Mesh Network.

Preferably, the status data generated by each alarm sensor can be in the form of electronic pulses and the BLUETOOTH module can be further configured to convert the electronic pulses into digital format.

In one embodiment of the present invention, the system may further comprise a cloud server connected to the controller. The controller can be further configured to forward the status data of each alarm sensor and alarm device to the server. Alternatively, the system may further comprise at least one computing device connected to the cloud server. The server can be configured to generate a push notification to the computing device when the alarm device is triggered.

In another embodiment of the present invention, the system may further comprise at least one camera connected to the controller via the BLUETOOTH Mesh Network. In this embodiment, the controller can be further configured to activate the camera to capture image or record video based on the status of the alarm sensors and to retrieve and forward the image or video to the server.

Alternatively, the computing device can be installed with an application for logged-in user to retrieve the image or video from the server and to display the retrieved data. The application can further provide a virtual button for logged-in user to trigger the alarm device through the server, and another virtual button for logged-in user to trigger the server to generate a status report and to retrieve the status report for display.

One skilled in the art will readily appreciate that the present invention is well adapted to carry out the objects and obtain the ends and advantages mentioned, as well as those inherent therein. The embodiments described herein are not intended as limitations on the scope of the present invention.

### BRIEF DESCRIPTION OF THE DRAWINGS

For the purpose of facilitating an understanding of the present invention, there is illustrated in the accompanying drawing the preferred embodiments from an inspection of which when considered in connection with the following description, the present invention, its construction and operation and many of its advantages would be readily understood and appreciated.

FIG. 1 is a schematic diagram illustrating a cloud based BLUETOOTH alarm system, in accordance to the preferred embodiment of the present invention.

FIG. 2 shows the process flow of account setting.

FIG. 3 shows the process flow of creating user account.

FIG. 4 shows the process flow of connecting a BLUETOOTH alarm controller to a server.

FIG. 5 shows the process flow of setting BLUETOOTH sensors and its secure modes.

FIG. 6 shows the process flow of retrieving data after login.

### DETAILED DESCRIPTION OF THE INVENTION

The present invention is described below with reference to flowchart illustrations and/or block diagrams of methods, apparatuses (systems) and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, that execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions/acts specified in the flowchart and/or block diagram block or blocks.

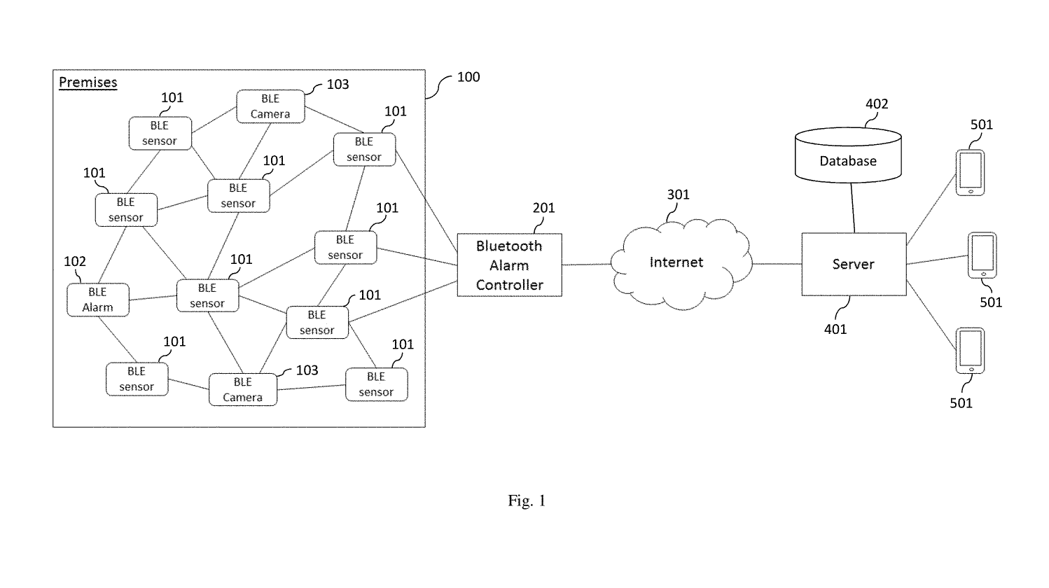

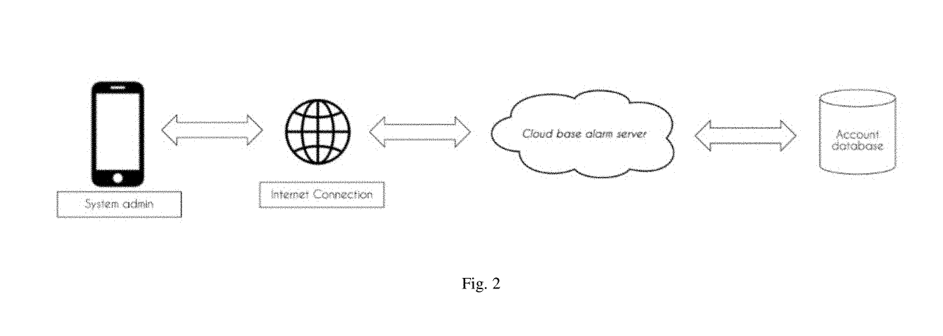

Referring to FIG. 1, a general architecture of a cloud based BLUETOOTH alarm system, as illustrated therein, includes a plurality of alarm sensors 101, at least one alarm device 102, at least one camera 103, a controller 201, a server 401, and at least one mobile device 501. The alarm sensors 101 can be magnetic contact sensors, motion detectors, smoke or carbon dioxide detectors, water sensors, glass break detectors, temperature sensors, heat detectors, sound detectors, roller/plunger sensors, photodetectors, or any combination thereof. The alarm device 102 can be any system or device that gives an audible, visual or other form of alarm signal about a problem or condition.

Each alarm sensor 101, alarm device 102, and camera 103 includes a BLUETOOTH module to establish communication link using a BLUETOOTH protocol to at least one neighbouring component 101-103 in a way such that a BLUETOOTH Mesh Network is formed, and the controller 201 connected to the BLUETOOTH Mesh Network, configured to monitor and manage the different devices 101-103. Preferably, the BLUETOOTH module employs BLUETOOTH Low Energy technology with mesh capability that enables many-to-many device communication and is optimised for creating large-scale device network. The BLUETOOTH module allows the respective device to be transformed into a network node with low energy consumption. In addition to that, the BLUETOOTH module can be configured to convert electronic pulse generated by the alarm sensor 101 into computer readable data for BLUETOOTH transmission within the BLUETOOTH Mesh Network. Under the BLUETOOTH Mesh Network technology, each sensor with the supported BLUETOOTH Mesh technology module can work as either a node or router. When it is working a router, it can receive BLUETOOTH signal from one source and broadcast it to the nearby nodes. As such, the BLUETOOTH coverage can be expand to further distance via a further node. Once the sensors are activated, they start to broadcast information via BLUETOOTH Mesh Network. The broadcast information includes sensor's serial number, type, battery status and health status (rest or trigger status).

The controller 201 includes a processor for processing data, the BLUETOOTH module to connect to the BLUETOOTH Mesh Network, a wired or wireless communication module for accessing internet 301 via a router, and a local storage for storing settings, configurations and temporary data. The BLUETOOTH module allows the controller 201 to establish communication link with devices which are connected to the BLUETOOTH Mesh Network. This enables the controller 201 to manage/control all the connected devices and to collect data from those devices.

The server 401 can be a cloud based service, operated by one or more heavy duty computers and any known devices or group of devices 402 to provide sufficient capacity for storing data. Preferably, the server 402 is linked to the controller 201 and the at least one mobile device 501 via internet 301. The server 401 serves as a cloud based platform to collect data from the controller 201, to process the collected data and generates status reports, to produce notification to the mobile device 501, to receive instructions from the mobile device 501 and forwards the instructions to the controller 201 for executing the designated operation, and to provide software updates to both the controller 201 and the mobile device 501.

The mobile device 501 can be a personal digital assistants (PDA), smart phone, tablet, laptop, netbook, phablet, phoblet, or any suitable means which capable of processing data and performing data transmission. Preferably, the mobile device 501 is installed with an application module configured to provide a user interface, to provide functional virtual keys or buttons for triggering different operations through the server 401, and to receive notification from the server 401.

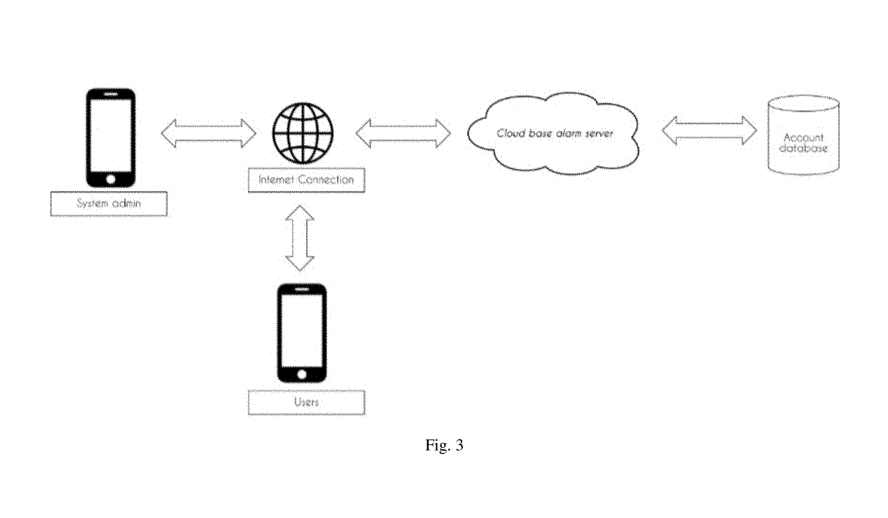

FIG. 2 illustrates the process flow of creating an admin account. The system admin can first create an account on the server through the application. The details of such information will be stored under an account database in the server.

FIG. 3 illustrates the process flow of creating a user account. The cloud based server is capable of handling operations for multiple users. In the first step, the system admin creates a new user accounts by using individual email address. The created user accounts will be stored into the account database and such information is under the control or supervision of the system admin. The server then sends invitation emails to the individual user to login and create login password through the application. In general, there are two types of account, one is the system admin account and the other one is the user account. The system admin account has full accessibility to the functions/operations of the alarm system and can restrict the accessibility of each user account by configuring access level of each user account. The user account only has partial accessibility to the functions/operations defined by the system admin. The password verification can be replaced by biometric verification, in which the biometric data of the system admin and the user can be acquired through a biometric module of the mobile device.

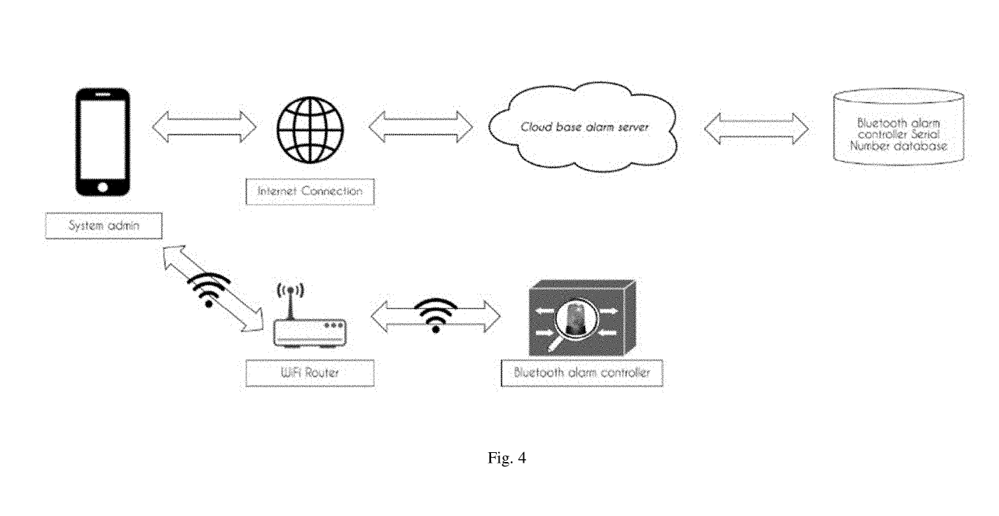

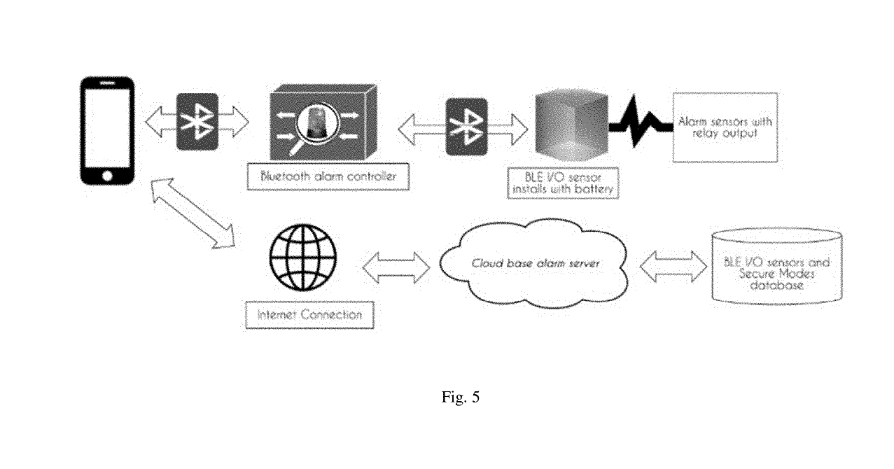

FIG. 4 illustrates the process flow of pairing a new controller to the server. Firstly, the system admin through the application submits the serial number of the controller to the server. The server shall verify the serial number and create a pairing password. The pairing password will be sent to the controller and to be stored within the local storage of the controller. This pairing password is the communication key between the application and the controller and this key must be inserted to pair the mobile device to the controller so that the paired mobile device can manage the controller.

FIG. 5 illustrates the process flow of configuring the sensors and its secure modes. The system admin firstly switch on the sensors to enable its BLUETOOTH module to detect and to establish a BLUETOOTH communication link with neighbouring sensors so that the BLUETOOTH Mesh Network can be formed. Once the BLUETOOTH Mesh Network is formed, the system admin can through the application connects the controller to the BLUETOOTH Mesh Network and detect all the sensors. The status of each sensor will be shown in the application and the system admin is allowed to rename each sensor and to categorise the sensors into different groups. The application also provides three different secure modes for each sensor, namely Day mode, Night mode, and 24-hours away mode. The system admin can select from the application a mode for a group of sensors or the sensors can be customised individually with their designated mode. The controller can also be configured to automate the triggering of alarm device upon detection of abnormal activity by the sensors.

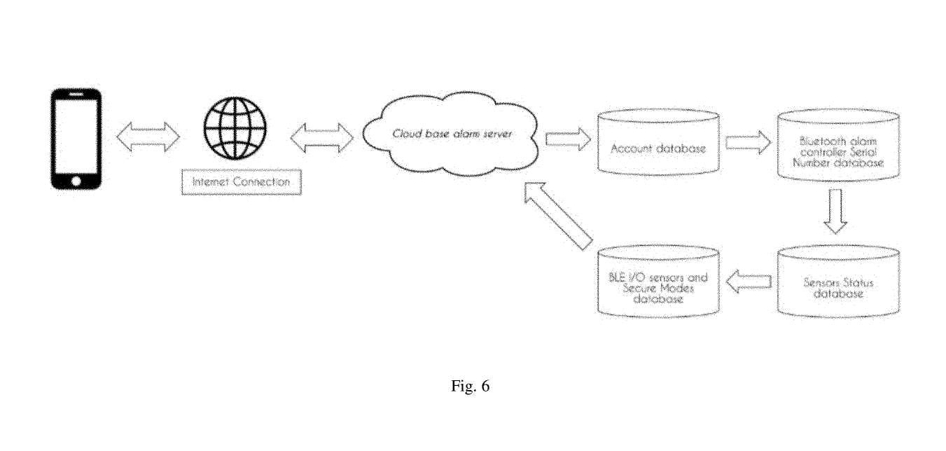

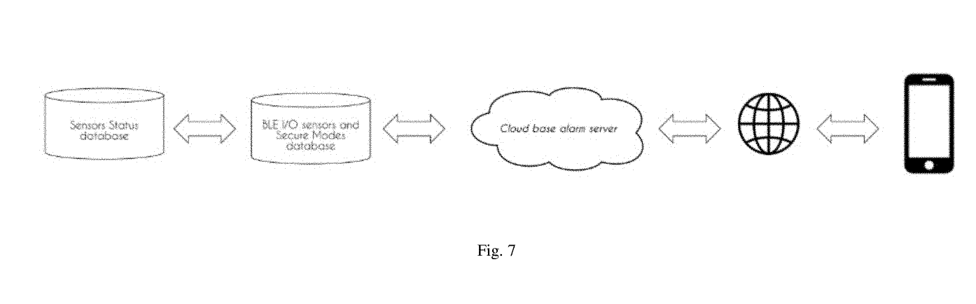

FIG. 6 illustrates the process flow of retrieving data upon system admin or user login. When the sensors are in a usual operation, the detection status and battery status of each sensor will be transmitted to the server via the controller in every predetermined period or in real time depending on the settings. The login of the system admin or the user into the application will triggers the server to firstly check access level of the account, determine controller that is paired to the account, check the list of sensors connected to the controller and individual status, and then forward the data to the application for displaying the condition of the alarm system in real time. The server can also determine the sensor's condition and the possible type alert detected based on the received data. Such condition can include but not limited to low battery condition, loss of connection, etc. Computer logics can be implemented to generate an alert message to the application if these conditions are met or such alert is detected. If the system admin detected deflective sensors, the system admin is also being provided with the option of bypassing or excluding the deflective sensors via the application. In addition to that, status report can be generated automatically depending on the preference of the system admin.

Alternatively, the camera can be connected to the controller via the BLUETOOTH Mesh Network. In this embodiment, the controller can be configured to activate the camera to capture image or record video based on the status of the alarm sensors and to retrieve and forward the image or video to the server. The system admin can also, through the application, retrieve the image or video from the server and manually triggers the alarm device if abnormal activity is spotted.

The present disclosure includes as contained in the appended claims, as well as that of the foregoing description. Although the present invention has been described in its preferred form with a degree of particularity, it is understood that the present disclosure of the preferred form has been made only by way of example and that numerous changes in the details of construction and the combination and arrangements of parts may be resorted to without departing from the scope of the present invention.

What is claimed is:

1. An alarm system comprising:
a plurality of alarm sensors, each having a BLUETOOTH module to establish communication link using a BLUETOOTH protocol to at least one neighbouring sensor in a way such that a BLUETOOTH Mesh Network is formed; and
a controller connected to the BLUETOOTH Mesh Network, configured to monitor and manage the status of each alarm sensor and to trigger at least one alarm device based on the status of the alarm sensors;
wherein the status data of each alarm sensor is transmitted to the controller, and vice versa, instructions of the controller are transmitted to at least one sensor via the BLUETOOTH Mesh Network.

2. The alarm system according to claim 1, wherein the at least one alarm device is connected to the controller via the BLUETOOTH Mesh Network.

3. The alarm system according to claim 1, wherein the status data generated by each alarm sensor is in the form of electronic pulses and the BLUETOOTH module is further configured to convert the electronic pulses into digital format.

4. The alarm system according to claim 1, further comprising a cloud server connected to the controller.

5. The alarm system according to claim 4, wherein the controller is further configured to forward the status data of each alarm sensor and alarm device to the cloud server.

6. The alarm system according to claim 5, further comprising at least one computing device connected to the cloud server.

7. The alarm system according to claim 6, wherein the cloud server is configured to generate a push notification to the computing device when the alarm device is triggered.

8. The alarm system according to claim 6, further comprising at least one camera connected to the controller via the BLUETOOTH Mesh Network.

9. The alarm system according to claim 8, wherein the controller is further configured to activate the camera to capture image or record video based on the status of the alarm sensors and to retrieve and forward the image or video to the cloud server.

10. The alarm system according to claim 9, wherein the computing device is installed with an application for logged-in user to retrieve the image or video from the server and to display the retrieved data.

11. The alarm system according to claim 10, wherein the application further provides a virtual button for logged-in user to trigger the alarm device through the cloud server.

12. The alarm system according to claim 11, wherein the application further provides a virtual button for logged-in user to trigger the cloud server to generate a status report and to retrieve the status report for display.
